(19) United States
(12) Patent Application Publication
(10) Pub. No.: US 2007/0274234 A1
(43) Pub. Date: Nov. 29, 2007

(54) NETWORK MANAGEMENT METHOD

(75) Inventor: Akinori KUBOTA, Fukuoka (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/754,132

(22) Filed: May 25, 2007

(30) Foreign Application Priority Data
May 26, 2006 (JP) 2006-147241

(51) Int. Cl. H04L 12/28

(52) U.S. Cl. 370/254

(57) ABSTRACT

The present invention provides a method in which the physical connection information and the logical network configuration information are kinked to the status of spanning tree, and the status of spanning tree is displayed with the physical connection and the logical network configurations. The method can provide the better recognition about not only intended the physical and logical configurations but the status of spanning tree to a network administrator. Therefore, the network administrator can integrally recognize the status of the network and the failure in the network will be analyzed easily to recover the network to normal state in shorter time.

### BACKGROUND OF THE INVENTION

(1) Field of the Invention

The present invention relates to a method for managing a network comprising a plurality of equipments, more specifically the method manages the network with use of information in addition of the information of physical connection among the equipments and the logical network construction information.

(2) Related Art

A network managing method or system are disclosed in Japanese unexamined application 10-294731 and 11-340980, in which a physical configuration of the network and logical configuration such as Virtual LAN (VLAN) are displayed in corresponding with each other.

In the systems as back ground, a control manager gathers information of network information, such as a method for identifying the physical connections, and corresponds to the information to logical network configurations including a Virtual LAN. The correspondence between both sets of information is displayed on a monitor, or the like.

Further in Japanese unexamined application 2004-326790, in which a physical a network system is capable of gathering, identifying, storing spanning tree information from equipments responsive to a packet internet groper and calculates to them for displaying the network topology as a physical connection configuration.

The many available network configurations include bypass roots for redundant paths. Therefore, the logical configuration of Layer 2 (VLAN) includes blocking points with cooperation of the spanning tree function to realize, construct, and maintain transmission paths. Further, each instrument learns and storages MAC addresses on the transmission paths.

When to monitor the above networks, it is important to find out the status of the real communicating paths, the status of learning MAC addresses. In case of finding the formation of the loop in network during changing the status of spanning tree, or during relearning the MAC addresses, an interruption temporarily occur by which the connection of the line between end-users can not be established.

The recognizing the status of the real paths and spanning trees are important to analyze accidents in the network. The techniques disclosed in the references 1 and 2 can acquire the physical and logical configuration of the network at most. The techniques disclosed in the references, however, are difficult to the status of real paths on the logical configuration of the network and a status of the learning of MAC addresses. Therefore it will take a lot of time to find and analyze troubles on the network and recover the line, because the analysis on the troubles will be done manually to investigate the status of the real transmission paths or the learning of MAC addresses and will be estimated the probable trouble portion.

Furthermore, the network apparatus disclosed in the Reference 3(Japanese unexamined publication 2004-326790 could not detect an operating status of a network, where a connection between ports of devices is not connected by a cable defect or wrong wiring in practice in spite of the intention of a network manager that the connection is really connected and available on the design of the network. The reason why the apparatus could not detect these statuses is depend on calculating only the physical configuration from the spanning tree which varies according to the status operating the network for obtaining the physical configuration which should be the designed physical and logical designed-configuration.

### SUMMARY OF THE INVENTION

It is an object of the present invention to provide the network managing method which the network manager can integrally grasp not only the physical and logical configurations of the system but the status of the spanning tree corresponding to the transmission paths.

Another object of the present invention is to provide a network managing method by which the network manager can grasp not only the physical and logical configurations of the network but a status of spanning tree corresponding to the transmission paths and a status of learning MAC addresses.

Further object of the present invention is to provide a method for managing network, the method is capable of detecting a status in which a available path is not previously assumed in a usual operating or a status of ordinal transmission paths and capable of detecting a status of learning a previously invalid MAC address, such that the MAC address designates a previously not assumed port and forms a loop on the network.

Note that the status includes probable failures in the network. Therefore, the object is directed to make a time for calculating and repairing the failure remarkably shorten in addition of the detections described above.

Furthermore the present invention is to provide a method for monitoring by which an administrator of the system can monitor reliably the network whether the system is operating in intended status of spanning tree, such as a status of transmission paths, and of learning MAC addresses. Accordingly there is provided the method by which the administrator easily estimate whether the system is operating satisfactorily or not.

The present invention provides the configuration in which the statuses of spanning tree and learning MAC addresses in each logical configuration of VLAN are associated and displayed with an object associating a physical configuration with a logical configuration. And the present invention includes the function for storing the history of the statuses and for comparing the difference between two histories of the statuses.

Furthermore, the present invention provides the configuration in which the physical configuration and the logical configuration are associated based on the setting information of devices designed by the network administrator, and provides displaying the status of spanning trees and MAC address learning status on the configuration.

By virtue of function of the present invention described above, the network administrator can integrally grasp not only the intended the physical and logical configurations but the status of spanning tree which is non-visible transmission paths and the Mac address learning status.

### As a result, the function contribute to easily analyze and recover the network when the transmission path accidents and the abnormal status of MAC address learning, therefore the recovery time will be shorten.

(1) The method for managing a network provided by the present invention including a plurality of nodes can display on a monitor an object in which the physical connection information and logical network configuration information are associated. And the method comprises; collecting status of spanning tree information operating on a logical network configuration from each of the network devices; storing the collected status of spanning tree information which is linked to physical connection information and logical network configuration information; displaying at every logical network configuration obtained on a monitor the status of spanning tree from the collected status of spanning tree information, physical connection configuration obtained from physical connection information, and logical network configuration obtained from logical network configuration information.

According to the present invention, the status of spanning tree at every logical network configuration is displayed on a monitor, where the status of spanning tree is stored in a form linked with physical connection information and logical network information. The network administrator, therefore, can grasp integrally not only intended physical and logical configurations but the status of spanning tree (STP). The interruption in the network can be easily analyzed and the recovery time to proper service in the network will be shortened.

The display provided by the present invention is shown in FIGS. 10 or 11 which is described in detail later. On the screen, a block diagram can be displayed comprising symbols representing the network devices, ports, the paths in the logical network configuration, the status of spanning tree. The logical network configuration information means the VLAN information which is shown in the embodiment later. Physical connection and logical network configuration information linked to status of spanning tree information are stored in the same manner as conventional one.

(2) Furthermore, the method for managing network provided by the present invention may include; collecting MAC address being learned by each of the network devices therefrom; storing the collected MAC address in a form in which the collected MAC address is linked to physical connection information, logical network configuration information, and status of spanning tree information; displaying a list of the collected MAC address associated with the ports of the network device in which the MAC address is learned.

Thus, according to the present invention, the MAC addresses collected from each network device are linked with the physical connection information, logical network configuration information, and the spanning status information and stored, and MAC addresses is displayed in a form of list with the ports of a network device learning the MAC address at every logical network configuration. Therefore, the network administrator can grasp the learning status of the MAC addresses of ports of each network device in addition of grasping the physical and logical configurations and the status of spanning tree.

The detail explanation will be described later as an embodiment, the list as an example of the embodiments described above can be shown in FIG. 13. On the list shown in FIG. 13, where the stored MAC address is displayed with associated ports of the network devices at every logical network configuration. Furthermore the sequence of learning of the MAC address can be displayed distinctively form other MAC address. For examples, the sequence of learning can be shown distinctively by use of arrows or the sequential numbers.

(3) Furthermore the method for managing network provided by the present invention comprises; storing previously stored physical connection configuration information, logical network configuration information, status of spanning tree information, and MAC address information into the storing means for storing history of collecting information in which physical connection information, logical network configuration information, status of spanning tree information, and MAC address information; displaying at least one of physical connection configuration, logical network configuration, status of spanning tree information, or MAC address information when receiving a request for selecting previously stored histories.

As described above, the collected and stored various pieces of information are stored as historical information and the various pieces of historical information can be displayed by the request from the network administrator. Then the network administrator can manage integrally the network in the present state, taking into the consideration the network in the previous state.

The present invention also improves the processing time for interruption analysis by the configuration for comparing the various kinds of information at a past time and other past time, or at a past time and the present time. For faster processing of interruption analysis, it is preferable to include configuration for detecting differences between the various kinds of information in two different times, where the past one of two different times is preferable to be a time closest to time before the interruption did not occur.

(4) Furthermore the method for managing network provided by the present invention comprises; estimating the abnormality in MAC address learning based on the relations between the status of spanning tree of the network devices and the ports where the MAC addresses are learned; at every logical network configuration, displaying an estimated result added on a list where the collected MAC address is associated with the ports where the MAC address are learned.

As an effect provided by the present invention, it is easily able to analyze the interrupt in the network because the abnormality is estimated from the relationship between the status of spanning tree information and the ports of the network device in which MAC address is learned, and the resultant abnormality is displayed. The abnormality is shown as example in FIG. 15, and a detail explanation will be described in later embodiment.

(5) Furthermore the method for managing network provided by the present invention further comprises; receiving a parameter and displaying the list of only the MAC address related to the received parameter on the display screen at every logical network configuration in the step where the collected MAC addresses are displayed as a list in which the MAC addresses are related to the ports in the network devices where the MAC addresses are learned.

As an effect provided by the present invention, the network administrator can check only the necessary information and analyze fast the interruption, because the list represents only the MAC addresses designated by the parameter and includes no MAC address not designated by the parameter.

For examples, parameters for selecting or filtering MAC addresses are:

(1) device as the parameter for all Mac addresses which are being learned a device,

(2) device and the port as parameter for MAC address being learning by the device,

(3) MAC address as the parameter the MAC address

The present invention described above can applied to apparatus or program, in other word, to the apparatus for monitoring network or the program usable for monitoring network.

The network devices include routers, layer 3 switch, switching HUB, Layer 2 switch. The logical network includes VLAN and VPN. The collection of the information can be started periodically or when the variation of the configuration or the status is detected and can be collected by the SNMP.

The steps of the method provided by the present invention can be execute as an example by the monitoring terminal in a embodiment, or a computer, a designated apparatus and the like, or more particularly CPU. The main characteristics of the present invention are described above, and therefore the sub-combination of the characteristics of the present invention can be inventions.

### BRIEF DESCRIPTION OF THE DRAWINGS

FIG. 1 shows a schematic diagram of the present invention.

FIG. 2 shows a schematic figure of a collecting and storing part for various kind of information in an embodiment of the present invention.

FIG. 3 shows a schematic figure of a history storing and processing part for various kind of information in an embodiment of the present invention in an embodiment of the present invention.

FIG. 4 shows a schematic figure of each of displaying and processing parts for a physical configuration diagram, a VLAN configuration diagram, and a STP status diagram in an embodiment of the present invention.

FIG. 5 shows an explanatory figure for of a displaying part for MAC address learning status in an embodiment of the present invention.

FIG. 6 shows a partially enlarged flow chart shown in FIG. 5.

FIG. 7 shows an explanatory figure of collected information data structure in an embodiment of the present invention.

FIG. 8 shows an explanatory figure of a physical configuration in an embodiment of the present invention.

FIG. 9 shows an example of displaying of VLAN configuration in an embodiment of the present invention.

FIG. 10 shows an example of STP status diagram regarding VLAN1 in an embodiment of the present invention.

FIG. 11 shows an example of STP status diagram regarding VLAN2 in an embodiment of the present invention.

FIG. 12 shows an explanatory figure of a MAC address learning status in VLAN2 in a normal case of an embodiment of the present invention.

FIG. 13 shows an explanatory figure of MAC address learning status list shown 12.

FIG. 14 shows an explanatory figure of a MAC address learning status in VLAN2 in a failure case of an embodiment of the present invention.

FIG. 15 shows an explanatory figure of MAC address learning status list shown 14.

### DESCRITION OF THE PREFERRED EMBODIMENT

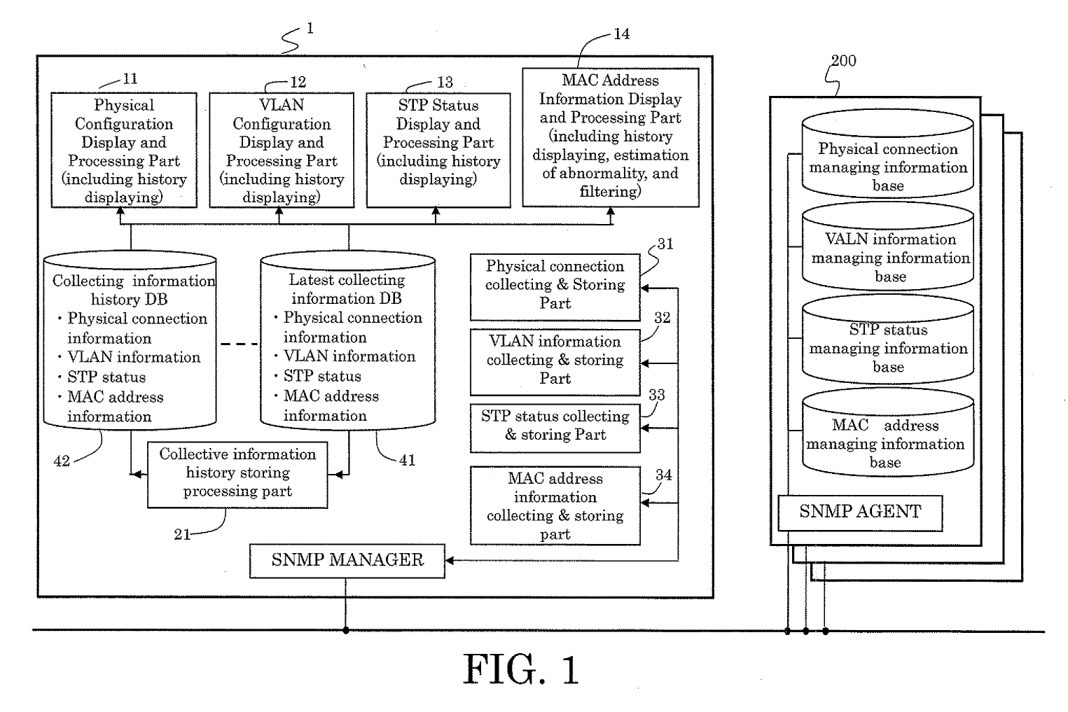

Referring to figures, the method for monitoring networks as an embodiment is explained. FIG. 1 shows a principal and schematic diagram of the embodiment.

On the network shown in FIG. 1, there are provided a monitoring terminal including a part of the present invention, a plurality of L3 and L2 switches as objects to be monitored.

The monitoring terminal 1 shown in FIG. 1 includes a simple network management protocol (SNMP) manager which uses a standard protocol “SNMP” for collecting necessary information from each of devices 200 to be monitored. Furthermore, the monitoring equipment 1 includes processing part comprising; a physical connection information storing part 11 for collecting and storing physical connection information; a VLAN information storing part 12 for collecting and storing VLAN information; a spanning tree storing part 13 for collecting and storing status of spanning tree; a MAC address storing part 14 for collecting and storing MAC addresses; a history storing part 21 for sorting history of information collecting; a physical configuration display part 31 for displaying the physical configuration and a history thereof; a VLAN configuration displaying part 32 for displaying the VLAN configuration and history thereof; a STP status displaying part 33 for displaying the status of STP and the history thereof; a MAC address displaying part 34 for displaying information of MAC addresses, a history, and estimating and filtering a failure; a latest collecting information database 34 for storing the latest collected information; a plurality of collected information history database 42 for storing a history of collected information. The monitoring terminal 1 is often referred to as Network management station.

Now each part is described more detail. The physical connection information storing part 11 collects physical connection information of each device on the network via a SNMP manager, and links and stores the collected physical connection information to and in the latest information storing database 41.

The VLAN information storing part 12 collects via SNMP manager the logical configuration information or VLAN configuration information which is allocated to each device 200 on the network and links the information with the physical connection information and then store the logical configuration information or VLAN configuration information in the latest information storing database 41.

The spanning tree storing part 13 collects via SNMP manager the information of STP status of each device 200 which operates on the logical configuration or VLAN configuration, and links the STP status information with the previously collected the physical connection information and the logical configuration information or VLAN configuration information which is allocated to each device 200 on the network. And then the spanning tree storing part 13 stores the linked information of STP status in the latest information storing database 41.

The MAC address storing part 14 collects from the device 200 the physical configuration information, VLAN configuration information and the MAC address information learned on the status of SPT via SNMP manager 200. And then the MAC address storing part 14 links the MAC address information to the previously collected physical connection information, the VLAN configuration information and the STP status information, and then stores the linked MAC address information in the latest information storing database 41.

The history storing part 21 has a function for reading information in the latest information storing database 41 and for storing the information into the collected information history database, where the information has been collected and stored in the latest information storing database 41. The physical configuration display part 31 has a function by which a physical block diagram based on the collected and stored physical connection information is displayed on the screen of monitoring terminal and the display part 31 further has a function for displaying the latest or a past history by specifying a database.

The VLAN configuration displaying part 32 has a function by which VLAN block diagram is displayed on the screen of monitoring terminal based on the collected and stored physical connection information and VLAN information. The displaying part 32 also has a function for displaying the latest or a past history by specifying a database.

The STP status displaying part 33 has a function by which STP status diagram of every VLAN is displayed on the screen of monitoring terminal based on the collected and stored physical connection information and VLAN information. The displaying part 32 also has a function for displaying the latest or a past history by specifying a database.

Based on the physical connection information, VLAN information and the STP status information which have been collected and stored, the MAC address displaying part 34 has a function by which MAC address information at every VLAN is arranged in a form of list associated with a port of device learned thereof, and the MAC address information is listed in a sequence of the distance from the device having the MAC address to a device and is displayed on the screen of monitoring terminal.

The MAC address displaying part 34 also has a function for displaying the latest history and the histories in past by specifying the database. Further the MAC address displaying part 34 has; a function which estimates trouble of the MAC address learning status by the calculation of association of the STP status and the port of the device which the MAC address has been learned and displays the list described above and the resultant estimation as a list; a filtering function for the list of MAC address associating with the specified parameter when the collected MAC address information is displayed at every VLAN.

The collection of each set of information can be started periodically or at the time when the variation of the configuration or the status is detected. And storing the history can be started also periodically or at the time when the variation of the configuration or the status is detected.

It is assumed that the devices 200 to be monitored shown in FIG. 1 are ordinarily used devices such as a L3 switch(router) and L2 switch (switching HUB), in which SNMP agent commonly used as a standard managing protocol for example, is implemented. Further the devices 200 have a management information base (MIB) for managing the physical connection information, VLAN information, STP status information, and MAC address information, and sends necessary information to monitoring terminal 1. As SNMP including SNMP agent, SNMP manager and MIB is well known for the person in the technical field, the SNMP can be properly implemented and used, the detail thereof is abbreviated.

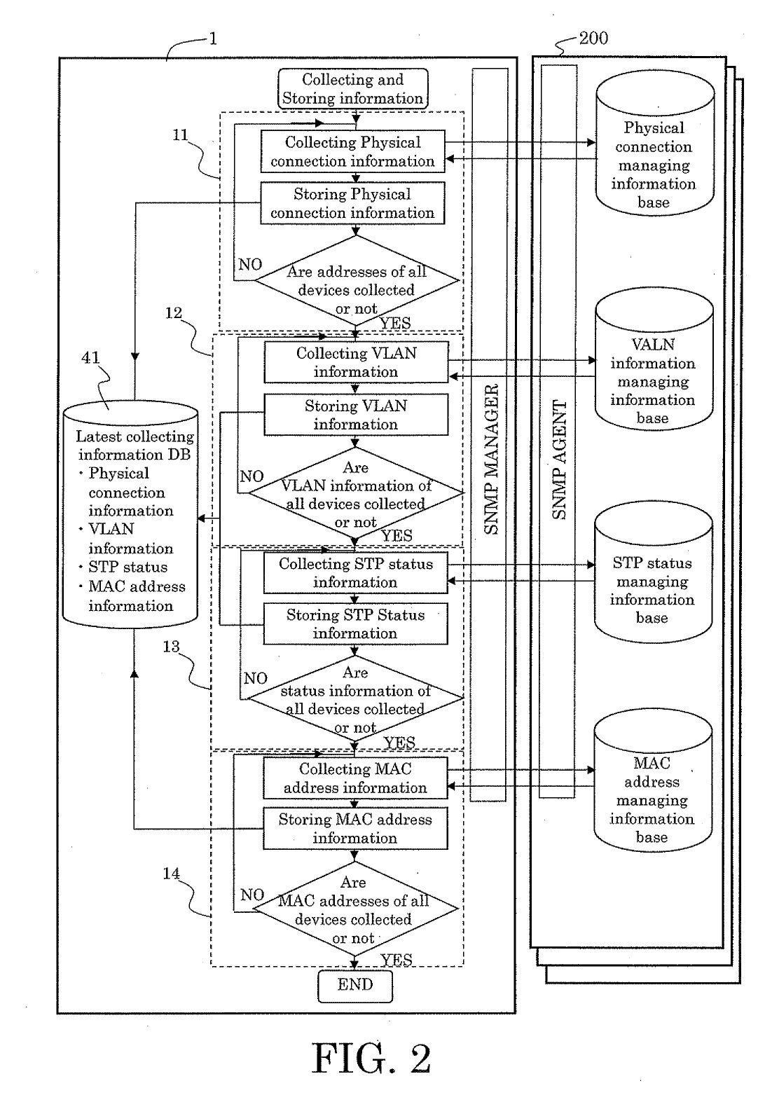

Next, referring to FIG. 2, the processing to collect and store various sets of the information is explained.

In step 110, the monitoring terminal I starts processing shown in FIG. 2 for collecting and storing information periodically or when the change of the configuration or status is detected. And the processing is executed in the sequence of the physical connection information storing part 11, the VLAN information storing part 12, the spanning tree storing part 13, and the MAC address storing part 14.

In the embodiment, the processes in the physical connection information storing part 11, the VLAN information storing part 12, the spanning tree storing part 13, and the MAC address storing part 14 are executed for all of the devices 200 to be monitored, while these processes may be executed for every device 200 to be monitored.

The physical connection information storing part 11 composes a SNMP-MIB acquisition sequence for collecting physical connection information of all ports of the device 200, then starts the SNMP manager, and collects the physical connection information of all ports from the physical connection managing information base in the device 200.

Collective physical connection information is stored the physical connection information storing area in the latest collected information DB41, where each of the set of physical connection information is sequentially linked to correspond device and port. This processing is repeated for the all device to be monitored. When storing the physical connection information, the physical connection information is overwritten as the information storing the area, if the same device and same port in the latest collected information DB41.

Next, VLAN information collecting and storing part 12 composes a sequence for obtaining SNMP-MIB for which all VLAN information is collected all VLAN information set on all ports of the device 200 to be monitored. Then SNMP manager starts, VLAN information collecting and storing part 12 VLAN information of all ports from VLAN information managing information of the object device.

Collected VLAN information is linked to the previously collected physical connection and sequentially stored at every devices, ports, and VLANs in the VLAN information storing area of the latest collected information DB41. This process is repeated for all devices to be monitored. When storing the collective VLAN information, the collective latest VLAN information is overwritten on the information storing the area, if the same device, same port, same VLAN information has been stored.

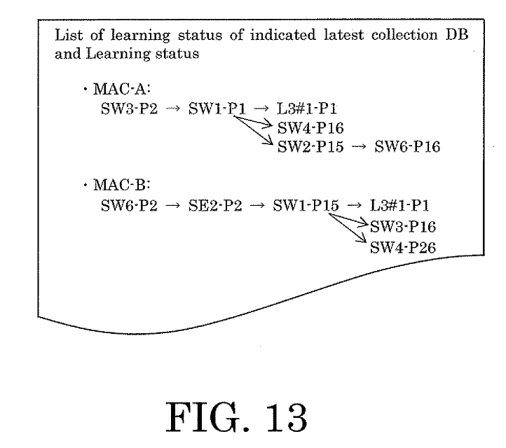

The STP status collecting and storing part 13 showing in FIG. 13 composes SNMP-MIB acquiring sequence in order to collect all STP status information which operates on all of the Logical VLAL configuration. And then the SNMP manager is started, and STP status information operates on all ports and whole VLAN is collected from STP status managing information base.

The collected STP status information is stored in the STP status storing area in the latest collected information DB41, where the STP status information is linked to the collected physical connection information and VLAN configuration information at every VLAN, every device or every port. The process is repeated for all devices to be monitored. When collective STP status information is storing, if there is a STP status information for same VLAN, same device, or same port, the STP status information stored in the area is overwritten as the latest STP status information.

The MAC address information collecting and storing part 14 shown in FIG. 2 composes SNMP-MIB acquiring sequence in order to collect all MAC address information which is learned on the device 200 to be monitor. And then the SNMP manager is started, and Mac address information is collected from MAC address information managing information base, where the MAC address information has been learned on the all ports, all VLANs, and ALL STP status.

The collected MAC address information is stored in the learned MAC address information storing area in the latest collected information DB41, where the MAC address information is linked to the collected physical connection information and VLAN configuration information at every VLAN, every learning MAC address, every learning device or every port. The process is repeated for all devices to be monitored. When collective STP status information is storing, if there is a STP status information for same VLAN, same device, or same port, the STP status information stored in the area is overwritten as the latest STP status information.

Further, collecting and storing of the each set of information are shown in executing in a flow chart like one stream, while collecting and storing of the each set of information may be executed individually by the instruction of the user. For the collecting physical connection information and VLAN information, it can perform to collect not through the SNMP but by manual editing and storing them into the latest collected information DB41.

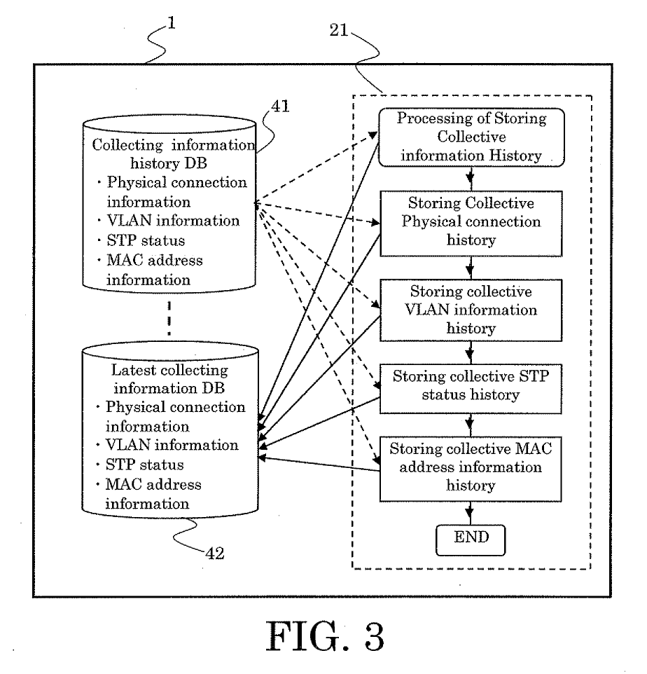

Referring to FIG. 3, the flow chart is for explanation of executing process of the storing processing part of the histories of various kind of information. In the monitoring terminal 1 shown in FIG. 3, the storing process part starts periodically or on the time of detecting the change of the configuration or the status. And a history storing and processing part 21 for sorting history of collective information executes the following processes in sequence; storing collective physical connection information history; storing collective VLAN information history; storing STP status history; collective MAC address information history.

In each of the process for storing histories, the information stored in the latest collected information DB1 is copied and stored on the collective information history DB42 area differing form DB41 with the date of storing the history, where the link statuses at collecting the information are maintained. The collective information storing process may configure such that the process of the individual history is executed by the instruction of the user.

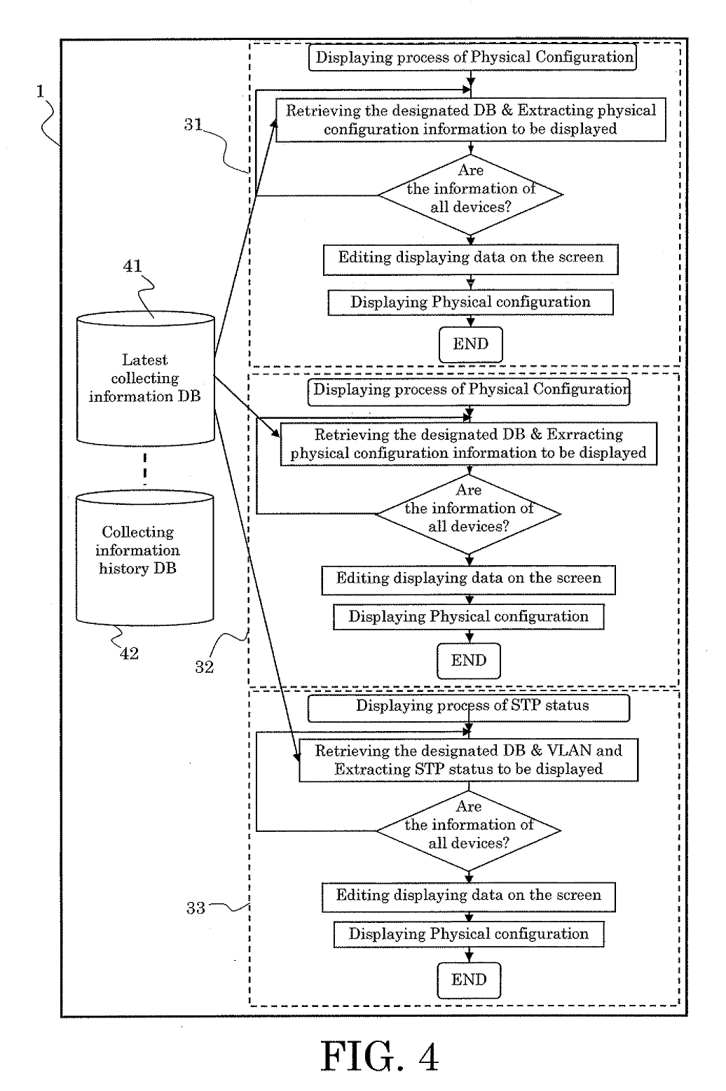

Referring to FIG. 4, the flow chart shown in FIG. 4 is dedicated to explanation of execution of process for each display processing part physical configuration diagram, VLAN configuration diagram, and STP status diagram which are displayed based on collected various set of information. The monitor terminal 1 shown in FIG. 4, the physical configuration displaying processing part 31, VLAN configuration displaying processing part 32, and the STP status displaying processing part 33 are individually started.

The physical configuration displaying processing part 31 executes; retrieving assigned DB41 and DB42; extracting physical connection information of all devices; editing icon of device, host name, port identifier, connecting line, and the like; and displaying physical configuration diagram on the screen of the monitoring terminal. It is also preferable to start the physical configuration displaying processing for renewing the image of physical configuration diagram displayed on the screen by when the data in DB41 according to the physical configuration has changed.

The VLAN configuration displaying and processing part 32 shown in FIG. 4 executes; retrieving the assigned DB41 or DB42; extracting physical connection information and VLAN information; editing data to be displayed on a screen such as an icons of device, host name, port identifier, physical connection information with or without VLAN tag, and connection lines for every VLAN; and then displays VLAN configuration diagram on the screen of monitoring terminal. During displaying VLAN configuration diagram on the monitoring terminal, it is also preferable configuration which starts the VLAN configuration displaying and processing part for renewing the image displayed on the screen when the physical configuration and VLAN configuration has varied and the data in DB41 has changed.

The STP status displaying and processing part 33 shown in FIG. 4 executes; retrieving the assigned DB41 or DB42; extracting physical connection information, assigned VLAN information, STP status information of assigned VLAN; editing data to be displayed on a screen such as an icons of device, host name, port identifier, VLAN connection lines; and STP status indicating each port being root bridge, blocking port or the like; and then displays the STP status diagram on the screen of monitoring terminal. During displaying STP status diagram on the monitoring terminal it is also preferable configuration which starts again the VSTP status displaying and processing part 33 for renewing the image displayed on the screen when the physical configuration, VLAN configuration has varied and the data in DB41 has changed.

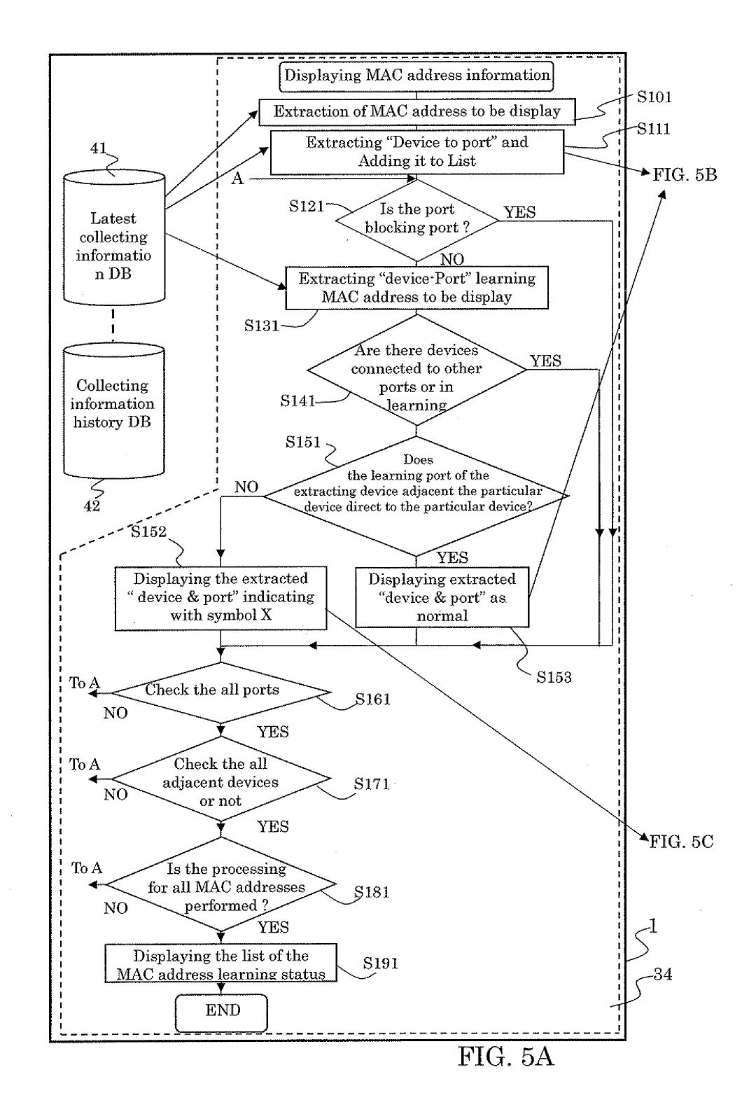

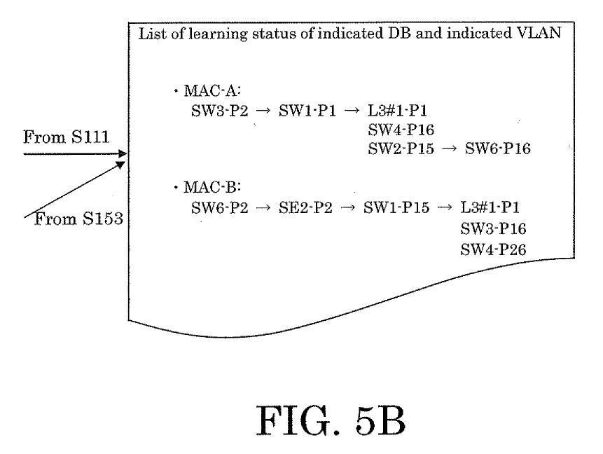

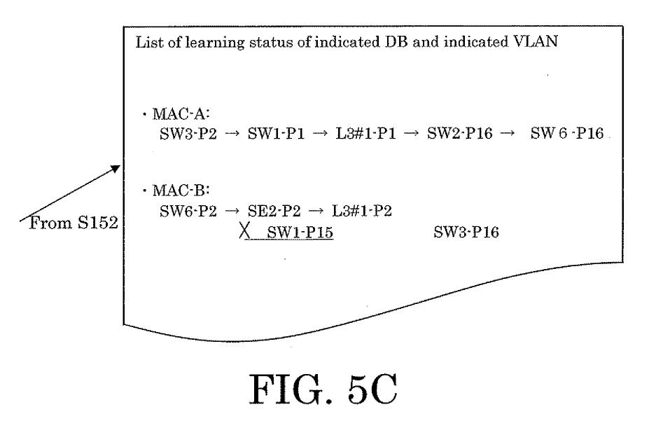

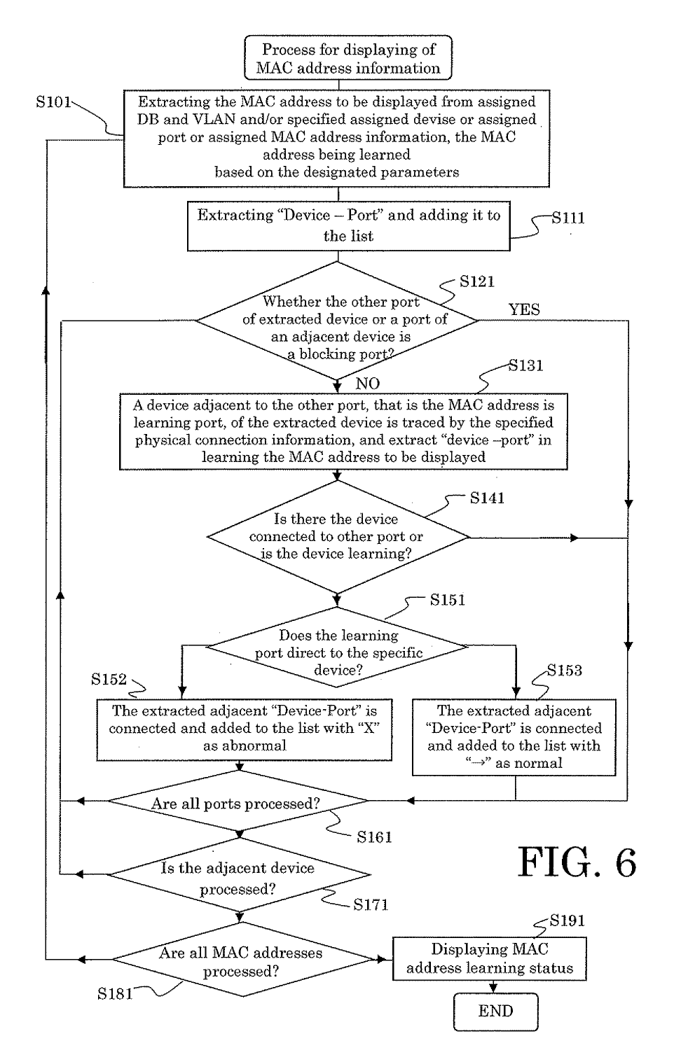

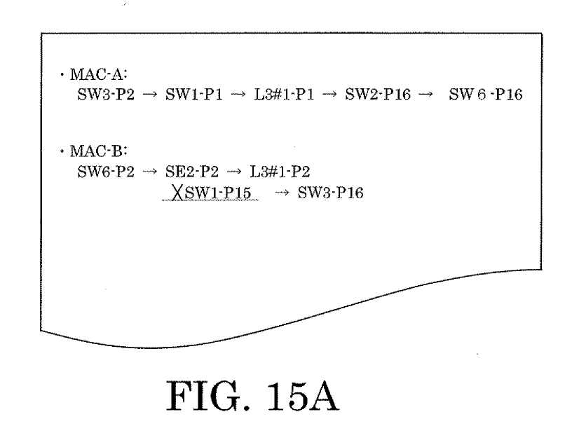

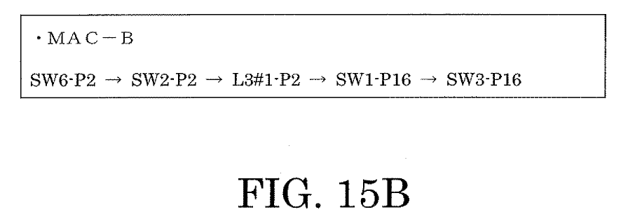

The flow chart of execution of display processing part is explained referring to FIG. 5, where the displaying processing part is for displaying MAC address learning status list based on the collective MAC address information. The part in the flow chart in FIG. 5 is shown in FIG. 6 as an enlarged chart. The both flow charts are substantially same, while different in figures. The list as an example shown in upper right of FIG. 5 is correspondent to the list shown in FIG. 13, the list shown in lower right is one in FIG. 15.

User's instruction starts the MAC address information displaying and processing part 31 in the monitoring terminal 1 shown in FIG. 5. Instead of the instruction, the part 31 can also be started periodically or when a variation of the configuration or state is detected.

In step 101, DB41 or DB42 is retrieved for extracting all MAC addresses which are learned on the assigned VLAN. In this execution, all MAC addresses information learned at the assigned devices or the port, or MAC addresses information related to assigned MAC address are extracted when filtering includes ‘device,’ ‘port,’ and ‘MAC address.’

In step 111, a pair of ‘device-port’ is extracted, where the device among the devices having learned the extracted MAC address has no port to be connected to the other port or the device has an adjacent port learning MAC address extracted from the other device to be connected the device. The device of the pair of ‘device-port’ is the closest device having the extracted MAC address. The pair of ‘device-port’ extracted is added to the learning status list.

In the case that the device in which the adjacent port is a port learning MAC address extracted from the destination device exists, the two fronts exist. So, the process about same MAC address is firstly processed one of two of combinations of “device-port” and completed, secondly other combination of “device-port” is processed. And resultant lists are displayed upper and lower. As the case of the existence of the two fronts, for example, a PC connected to HUB capable of no learning function of MAC address is connected to two devices such as HUBs capable of learning of MAC addresses. In this case, the device having the same MAC address has the closest two devices.

Next, in the device of the extracted “device-port,” the other ports, which is not learning the MAC address, or judge whether STP status of the port of the device adjacent to other ports is the broking port or not in step 121. When the port of STP status is the broking port, the process serves processing of other port. Both ports are not the broking ports, the device adjacent to the other port of the device through the physical connection information, and extract “device-port” learning extracted MAC address in Step 131. At this step,

In Step 141, when there exist an adjacent device connected to other ports, and the extracted MAC address is learned, in step 151 it is judged whether the learning port of the adjacent device connected to other ports is directed to the specific device or in the adjacent relationship. When the learning port of the adjacent device connected to other ports is not directed to the specific device, the learning state is estimated as abnormal, and the extracted “adjacent device-port” is in abnormal state with marking “X”, without connecting the marking “→”, and then added to the learning status list in step 152. When the learning port of the adjacent device connected to other ports is directed to the specific device, the learning state is estimated as normal, and the extracted “adjacent device-port” is in normal state with connecting by marking “→,” and then added to the learning status list in step 153. And then, the process is done for next port repeatedly. And in step 161, it is judged whether the process is done for all of the port or not. If unprocessed port is there, the process returns to step 121 for an unprocessed port.

In step 171, it is judged whether the processes for all the adjacent devices have been successfully executed or not when the processes for all the other ports has been done. If not, the process returns to step 121 to process the next extracted as an object to be processed. When processing for all the adjacent devices is executed, it is judged in step 181 whether the processing for all the MAC addresses is completed or not. If the processing is not completed, the process is returned to step 101, in which the next object MAX address is extracted and, the process for adding (the MAX address) to the learning state list.

### When all the MAC addresses as objects are completed, in step 191 the MAC address learning status list is displayed on the screen of a monitor terminal.

Further, it is preferable to configure the information displayed on the screen so as to display resultant new information by executing again MAC address information display part when any of the physical configuration, the responsive VLAN configuration, the STP status, or MAC address learning status is varied or the content of the latest collected information Data Base.

Further, it is also a preferable configuration (not shown) that the administrator can be notified the abnormality in MAC address learning status by the conventional alarming function provided in the existent network management system when the abnormality can be estimated. The abnormality will be estimated when the execution of “the process for preparation of MAC address learning status” before displaying the MAC address learning status list, which is created in MAC address information display processing part 34 and will be displayed on the screen of the monitor terminal. The execution is performed after the processing for MAC address information collecting and storing part 14.

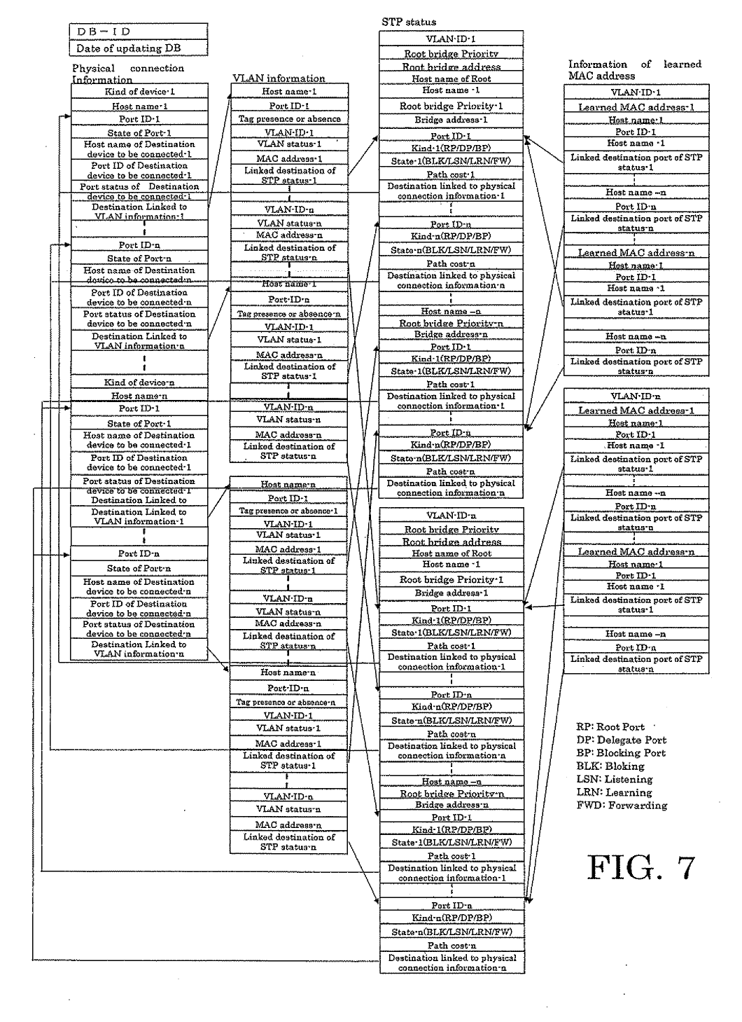

FIG. 7 shows the example of data structure in the collected information data base provided by the present embodiment. The data structure in FIG. 7 also shows the data in the latest collected information data base and the collected information history data base. The management information of the data bases includes DB identifier and DB renewal date and time.

The area for physical connection information includes a structure for storing the host name information, the information of a plurality of ports for each device. For more detail, the information of port include the information concerning to the port identifier, port status, a host name of the device at connection destination, the port identifier the device at connection destination, the port status of the device at connection destination, and the linked destination of VLAN information.

The area for VLAN information, shown in FIG. 7, includes a structure for storing the information of host name and the information of a plurality of ports for each device and port. For more detail, the information of port includes the information concerning to the port identifier, the presence or absence of VLAN tag, a plurality of set of VLAN information. Further the plurality of set of VLAN information includes information concerning to VLAN-IC, VLAN status, MAC address assigned to VLAN, and the linked destination of STP status port status.

The area of STP status shown in FIG. 7 includes a structure at each of VLAN-IDs for storing the information concerning to; root bridge priority as the information of root bridges in the VLAN; address of the root bridge; and the host name of the root bridge, and further includes a structure at each of devices and ports of the devices for storing the information concerning to; the host name; the root bridge priority; the bridge address; a plurality of set of port information. The plurality of set of port information further includes information concerning to; the port identifier; kinds such as RP, DP, or BP; status such as BLK, LSN, LRN, or FWD; path cost; and a destination linked to physical connection information port.

The area of the learning MAC address information shown in FIG. 7 includes a structure at each of VLAN-IDs and each of MAC addresses learned in the VLAN for storing the information concerning to; the learned MAC address; the device learning the Mac address; a plurality of devices at each of the ports; and port information including host name, port identifier, the destination linked to STP status port.

Each of the area described above has the structure for storing the linked destination shown graphically by arrow such as “→” and the collected data are edited and are linked to associated information to stored in the each of collection and storing parts.

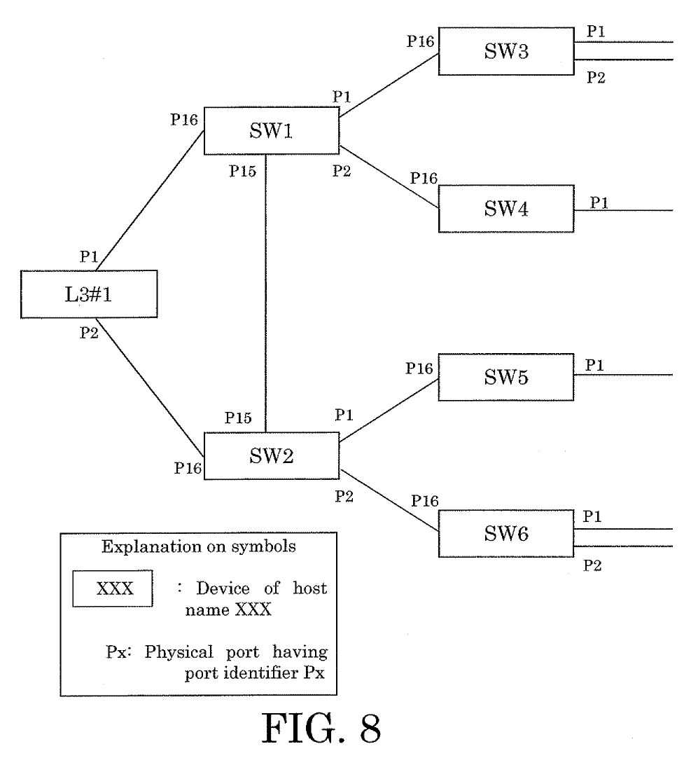

Next, the specific examples of the physical configuration diagram, the VLAN configuration diagram, and STP status diagram are explained. FIG. 8 shows an example of the physical configuration of the present embodiment and L3 switch is placed in right and L2 witch is placed in right of the L3 switch.

For more reliable monitoring on network, L3 switch is located as a basic point and the L2 switches are located lower to be connected the L3 switch. The identification of L3 switch is determined by the kind of device which is collected. The host name and the port identifier of each device are displayed. And the lines between each of devices are based on the information and displayed.

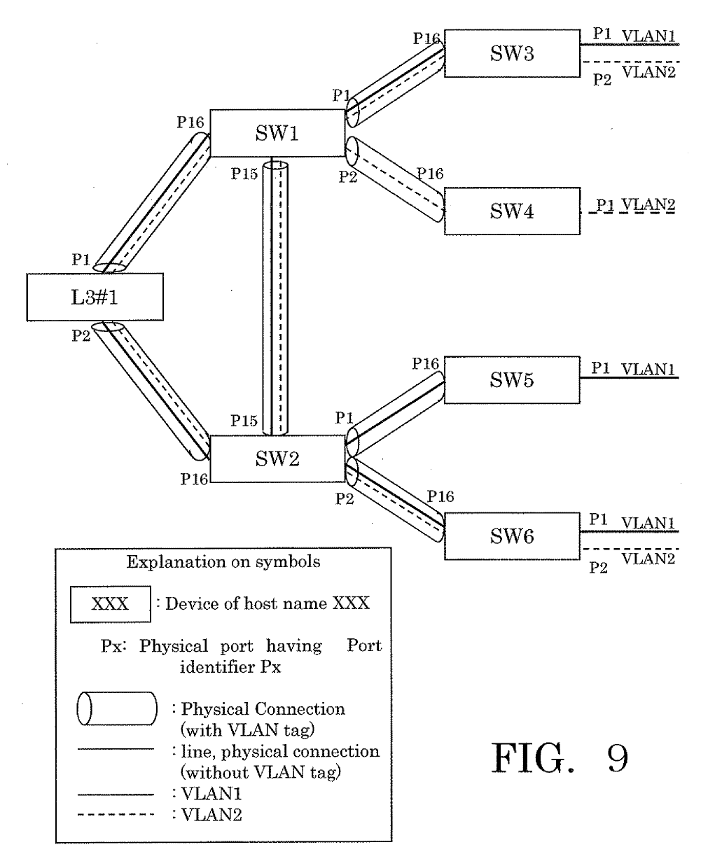

FIG. 9 shows an example of displaying VLAN configuration diagram of the embodiment, where VLAN1 and VLAN2 are added to the physical configuration shown in FIG. 8.

In FIG. 9, positions, hostname and port identifiers of each device are according to the physical configuration diagram, and the connection lines between the devices are based on the presence or absence information of VLAN tag at each port. When there are VLAN tags at the ports of devices, the lines between the ports of devices are displayed with cylindrical lines for easier recognition of physical configuration as shown in FIG. 9, while solid or dotted lines are used for displaying the physical connection between ports when the ports have not the VLAN tags. Further, in order to identify each of the VLANs between the ports having VLAN tag, the solid and dotted lines within the cylindrical line are used.

The ports having no VLAN tag are associated with a single VLAN, the solid or dotted lines are used and graphically show the physical connection. At the single or plural positions around each line, each VLAN-ID is displayed to identify the each line.

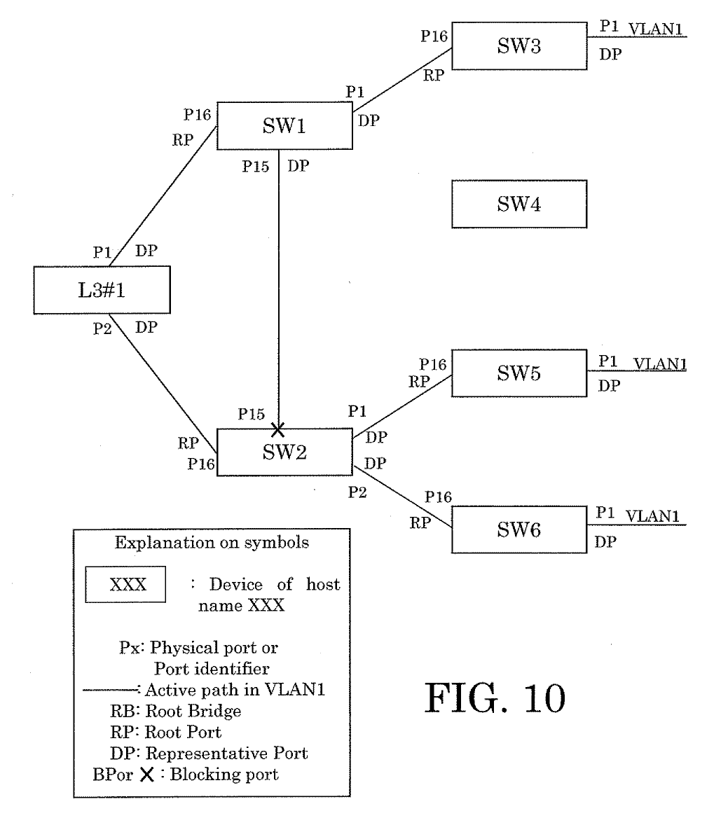

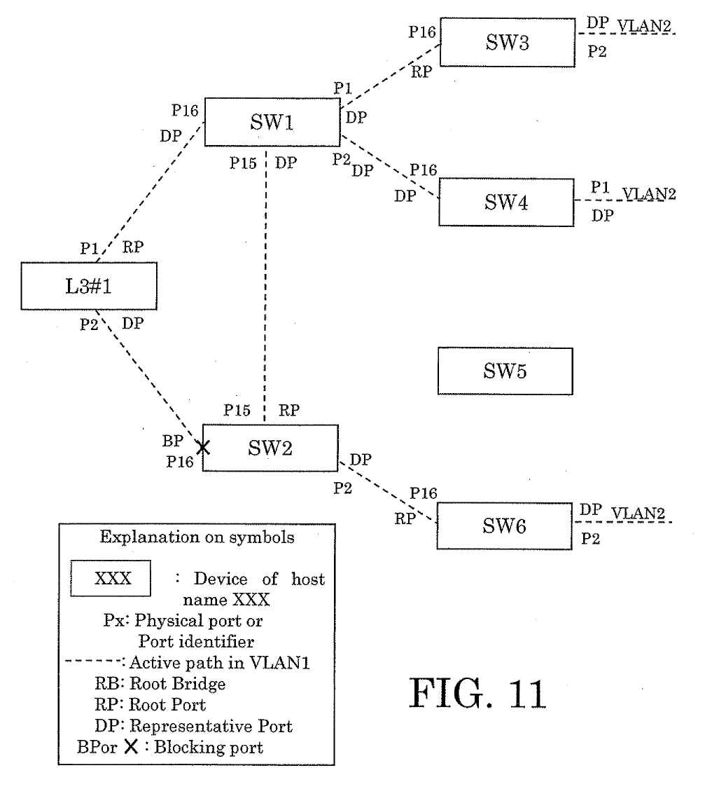

FIGS. 10 and 11 are STP status diagram examples of every VLAN of the present embodiment. FIG. 10 shows the example of STP status diagram regarding VLAN1, and FIG. 11 regarding VLAN2.

The positions, the host names and port identifiers of each device in FIGS. 10 and 11 are identical to those in the physical configuration and VLAN configuration diagrams. The connection lines between the devices in each of FIGS. 10 and 11 are identical to the solid or dotted lines which are shown in FIG. 9 and set in a corresponding VLAN. The way of these representations can show the ports associating with the STP operating on the corresponding VLAN.

Further “RB” shown under the host name of the device indicates the root bridge. In FIG. 10, the root bridge in the VLAN1 is L3 switch indicated as L3#1, and in FIG. 11, the root bridge in the VLAN2 is similarly L2 switch indicated as SW4.

Further, in FIGS. 10 and 11, RP as a root port, DP as the representative port, and BP as blocking port are shown close to each port identifier of the device, where RP, DP, and BP show the status of the STP. The blocking port is shown by the mark “X” near to the corresponding port.

The port P15 in SW2 as L2 switch in FIG. 10 is a blocking port in the VLAN1, and the port P16 in SW2 as L2 in FIG. 11 is similarly a blocking port in VLAN2.

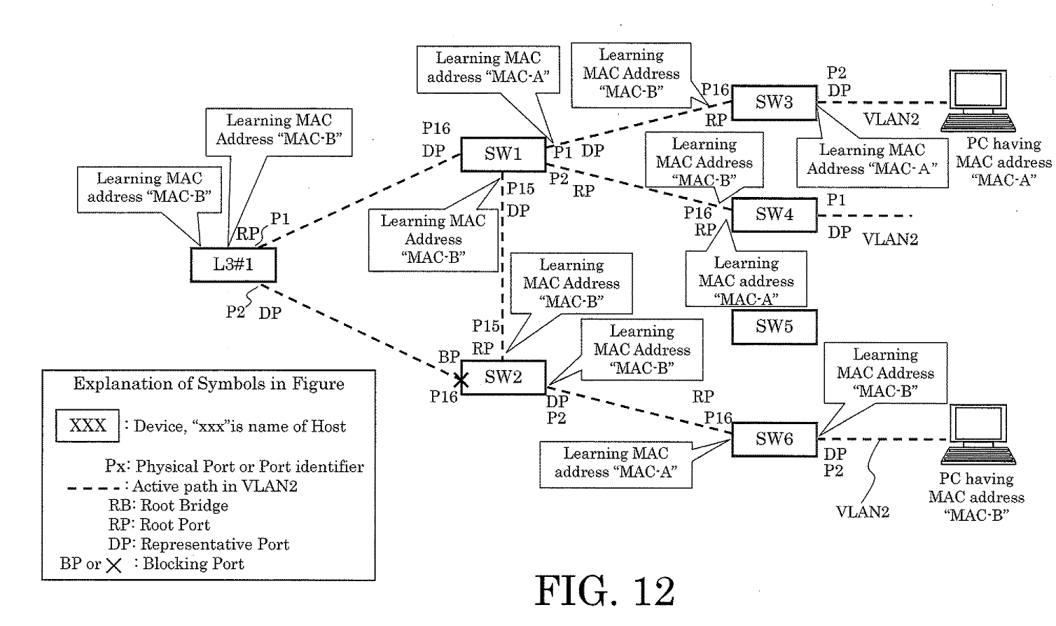

Next, detailed examples of displayed MAC address learning status list are shown and explained in normal and failed cases. FIG. 12 shows MAC address learning status in VLAN2 in a normal case as the present embodiment.

In the example shown in FIG. 12, a personal computer (PC) having MAC-A as MAC address is connected to P2 of SW3, and PC having MAC-B as MAC address is connected to P2 of SW6. FIG. 12 shows STP statuses of each device and learning statuses of both devices having MAC-A or MAC-B as MAC address.

The MAC address “MAC-A” is learned at P2 of SW3 closest to PC having the MAC address “MAC-A”, at P1 of SW1, at P1 of L3#1, at P16 of SW4, at P15 of SW2, and at P16 of SW6.

The MAC address “MAC-B” is learned at P2 of SW3 closest to PC having the MAC address “MAC-B”, at P2 of SW2, at P15 of SW1, at P2 of L3#1, at P16 of SW3, and at P16 of SW4.

In this state, when MAC address information displaying processing part is activated, the learning status list shown in FIG. 5. Regarding MAC-A, SW3-P2 as a forehead and a closest to the PC having MAC-A as a MAC address is linked with the marks “→”to SW1-P1 of the device adjacent to the learning port of SW3 except P2. And then, the devices adjacent to the learning ports of SW1 except P1 are L3#1, SW4, and SW2, and L3#1-P1, SW4-P16, and SW2-P15 are the learning port of each device, respectively, then the adjacent ports such as SW1-P16 and L3#1-P1 is linked with the mark“→”. Further, the devices adjacent to the learning port SW2 except P15 are L3#1 and SW6, but P16 of SW2 is blocking port, then L3#1 is not further linked as shown in FIG. 13, while SW6 is processed so as to be linked between SW2-p2 and SW6-P16. As a result, six ports in total are linked by the marks “→” in order to the adjacent relation, and the ports with the marks are added the list as shown in FIG.13.

Regarding MAC-B, SW6-P2 as a forehead and a closest to the PC having MAC-B as a MAC address is linked with the marks “→” to SW2-P2 of the device adjacent to the learning port of SW6 except P2. And then, the devices adjacent to the learning ports of SW2 except P2 are L3#1, SW1. The port P16 of SW2 is the blocking port then the device L3#1 is not processed further, while SW1 is processed further to link the port 15 of SW2 the port 15 of SW15. And the devices adjacent to the learning port except P15 of SW1 are L3#1, SW3, and SW4. The port L3#1-P1, SW-P16, and SW4-P16 are linked to the corresponding ports of SW1. As a result, six ports in total are linked by the marks “→” in order to the adjacent relation, and the ports with the marks are added the list as shown in FIG.13.

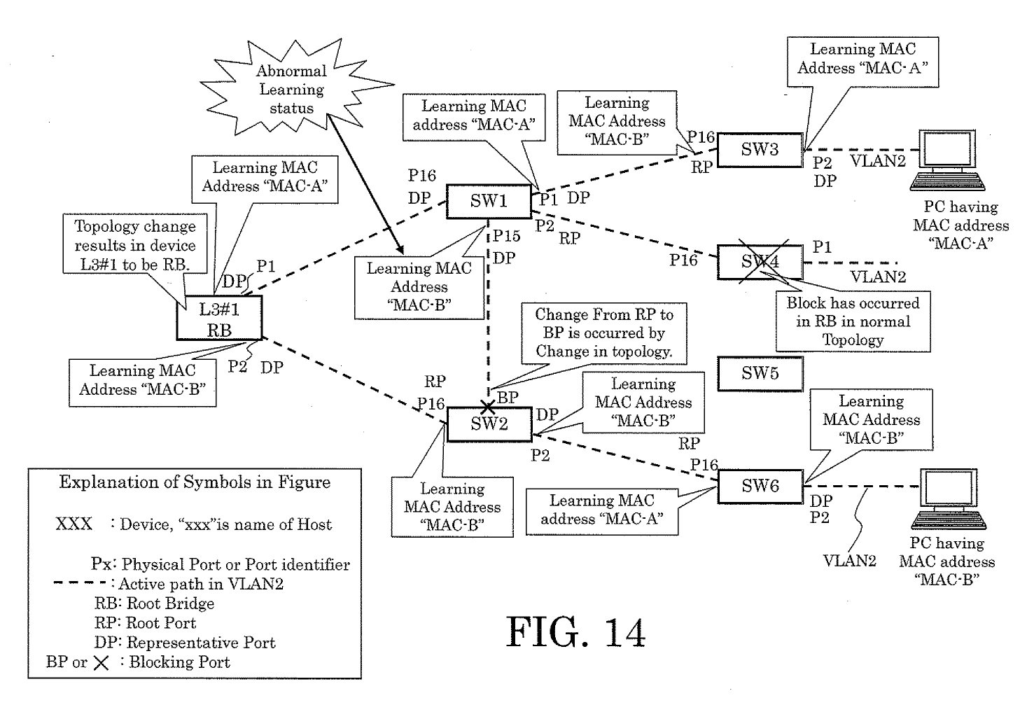

FIG. 14 shows a diagram of a MAC address learning status in a failed case in VLAN of the present embodiment. In this case, the PC having MAC-A as MAC address is connected to the port P2 of SW3, and the PC having MAC-B as MAC address is connected to the port P2 of SW6, where SW4 usually being root bridge is failed. FIG. 14 shows a STP status of each device in VLAN2, and the learning statuses of the devices having MAC address MAC-A and MAC address MAC-B. It is supposed that the learning status of SW1 concerning MAC-B is become into abnormality by the reason of some kind.

MAC-A is learning at the port P2 of SW3 closest to PC having MAV-A as MAC address, at the port P1 of SW1, at P1 of L3#1, P16 of SW2, P16 of SW6, respectively. MAC-B is learning at the port P2 of SW6 closest to PC having MAV-B as MAC address, at the port P2 of SW2, at P1 of L3#1, P15 of SW1, and P16 of SW3, respectively. The learning status of port P15 of SW1 is supposed as being failed.

In this state, when the PC having MAC-A is going to communicate with the PC having MAC-B, the packet to be relayed is cancelled because P15 in SW2 as a destined apparatus to carry out relay is blocking port. Therefore the failure in the communication between the two PCs will occurs. In this state, the learning status list shown in FIG. 15 when the MAC address information display processing part shown in FIG. 5.

Regarding MAC-A, SW3-P2 as a forehead and a closest to the PC having MAC-A as a MAC address is linked with the marks “→” to SW2-P2 of the device adjacent to the learning port of SW3 except P2. And then, the devices adjacent to the learning ports of SW1 except P1 are L3#1, SW4, and SW2. However SW4 being in failure is not processed, and the port 15 of the adjacent SW2 is not processed also because the port 15 is a blocking port. While the L3#1 is processed, MAC address is learned at the port of L3#1-P1. The devices adjacent to SW2 except the learning port P16 are SW1 and SW6, where the port 15 is the blocking port and then the SW1 is not processed, while SW6 is processed to learn the status of SW6-P16. Therefore, As a result, five ports in total are linked by the marks “→” in order to the adjacent relation, and the ports with the marks are added the list as shown in FIG. 15.

And then, the devices adjacent to the learning ports of SW2 except P2 are L3#1 and SW1. However the P15 of SW2 is a blocking port, and the SW1 is not processed while only L3#1 is processed and the MCA-B is learned at L3#1-P2, further the device adjacent to L3#1 except the learning port P2 is SW1-P16, however, as the learning port P15 does not direct to L3#1, then the learning status in SW1 is considered as abnormal and the mark “X” is attached to L3#1-P15 without using the mark “→” and added to the list. The three ports SW6-P2, SW2-P2, and L3#1-P2 are connected with the marks “→” in turn and add to the list.

After then, the process is started at SW1, the devices adjacent to except the learning port P15 in SW1 and the port 16 adjacent to L3#1 are SW3 and SW4. SW4 is not processed because of failure, while only the SW3 is processed. SW1-P15 with the mark “X” shown the abnormality and SW3-P16 are linked with the mark “→”, and SW1-P15 and SW3-P16 are added to the list. If the learning of MCA-B is normal, the displayed sequence is, for example, SW6-P2→SW2-P2→L 3 # 1-P 2→SW 1-P 1 6 →SW3-P 1 6.

As explained above, the present invention corresponds the physical to the logical configurations (hereinafter referred as VLAN) based on the devices information set and designed by the network administrator, and the spanning trees status, and MAC address, and learning status are displayed in a form associated each other. And the history of these are stored, and then the configuration possible to compare the difference the statuses. By this configuration, the administrator can grasp integrally not only the intended the physical and logical configurations but the status of spanning tree, which is invisible the status of communication, and MAC address learning status. The present invention can provide the capability of detection of the state in which the communication paths out of the normal predetermined operations are performed or the MAC address learning status out of the predetermined status, that is the status in which the MAC address is learned by predetermined ports caused by the loop or is a state before the failure is occurred. Therefore the present invention can provide to easy analysis against the failure such as the difficulties of communication paths and the abnormality in the status of MAC address learning, which serves the shorten to recovery to normal status of the communication.

Furthermore, the administrator can surely monitor the status of the spanning tree, which is the communication paths, and the status of learning MAC address, and the easily monitoring method by the administrator.

The present invention is explained with the embodiment described above, but the scope of technical range of the present invention is not limited within the embodiment. It is possible to various modifications, changes, or improvements to the present invention. And the embodiments added these are included in the scope of the present invention, which are reasonably apparent by the claims and the means for solving the problem.

What is claimed is:

1. A method of network management comprising:
a step of collecting information including a status of spanning tree from a device included on a network;
a step of linking the information including the status of spanning tree to both information of physical connection configuration and information of logical network configuration;
a step of storing the information including the status of spanning tree linked to both the information of physical connection and the information of logical network configuration; and
a step of displaying the status of spanning tree, the physical connection configuration, and the logical network configuration at each the logical network configuration.

2. A method of network management according to claim 1 further comprising:
a step of collecting a MAC address at each of devices on the network, the each of devices being learning the MAC address;
a step of linking information including the MAC address to information of the physical connection configuration, the information of the logical network configuration, and information of the status of spanning tree;
a step of linking the MAC address to a port of the each of device, the MAC address being learned at the port; and
a step of displaying a list including the MAC address and the port at each the logical network configuration.

3. A method of network management according to claim 1 further comprising:
a step of storing histories of each of the information of the physical connection, the information of the logical network configuration, the information of the status of spanning tree, and the MAC address; and
a step of selecting at least one of the information of the physical connection, the information of the logical network configuration, the information of the status of spanning tree, or the MAC address; and
a step of displaying selected one of the information of the physical connection, the information of the logical network configuration, the information of the status of spanning tree, or the MAC address.

4. A method of network management according to claim 2 further comprising:
a step of estimating a failure of learning the MAC address by a relation of the status of spanning tree of each the network devices and the port in which the MAC address is learned; and
a step of displaying the list and a resultant estimation of the failure at the each logical network configuration.

5. A method of network management according to claim 2 further comprising:
the step of displaying further comprising a step of receiving a parameter indicating a specific MAC address of the MAC addresses and displaying a list of the specific MAC address.

6. A method of network management comprising:
a step of collecting information including status of spanning tree from a device included on a network;
a step of linking the information including the status of spanning tree to both information of physical connection configuration and information of logical network configuration;
a step of storing the information including the status of spanning tree linked to both the information of the physical connection and the information of the logical network configuration; and
a step of displaying the logical network configuration and at least one of a kind of port, a status, a root bridge of each the device at each of the logical network configuration, the kind of port, the status, and the root bridge extracted from the status of spanning tree.

7. An apparatus for managing a network comprising:
means for collecting information including status of spanning tree from a device included on a network;
means for linking the information including status of spanning tree to both information of physical connection configuration and information of logical network configuration;
means for of storing the information including status of spanning tree linked to both the information of physical connection and the information of logical network configuration; and
means for displaying the status of spanning tree, the physical connection configuration, and the logical network configuration at each the logical network configuration.

8. A medium including a program for executing steps comprising:
a step of collecting information including status of spanning tree from a device included on a network;
a step of linking the information including status of spanning tree to both information of physical connection configuration and information of logical network configuration;
a step of storing the information including status of spanning tree linked to both the information of physical connection and the information of logical network configuration; and
a step of displaying the status of spanning tree, the physical connection configuration, and the logical network configuration at each the logical network configuration.

9. A method of network management according to claim 2 further comprising:
a step of storing histories of each of the information of the physical connection, the information of the logical network configuration, the information of the status of spanning tree, and the MAC address; and
a step of selecting at least one of the information of the physical connection, the information of the logical network configuration, the information of the status of spanning tree, or the MAC address; and
a step of displaying selected one of the information of the physical connection, the information of the logical network configuration, the information of the status of spanning tree, or the MAC address.
